(19) United States
(12) Patent Application Publication
(10) Pub. No.: US 2015/0041517 A1
(43) Pub. Date: Feb. 12, 2015

(54) FASTENER FEEDING DEVICE FOR A DRIVING TOOL

(71) Applicant: BASSO INDUSTRY CORP., Taichung (TW)

(72) Inventors: An-Gi Liu, Taichung (TW); Fu-Ying Huang, Taichung (TW)

(73) Assignee: BASSO INDUSTRY CORP., Taichung (TW)

(21) Appl. No.: 14/455,040

(22) Filed: Aug. 8, 2014

(30) Foreign Application Priority Data
Aug. 9, 2013 (TW) 102128685

(51) Int. Cl. B25C 1/00; B25C 1/08

(52) U.S. Cl. CPC B25C 1/003; B25C 1/08
USPC 227/136

(57) ABSTRACT

In a fastener feeding device for a driving tool, in response to a rearward displacement of a contact arm, a carrier member is displaced from an upper position to a lower position, and a claw end of a claw member is dragged downward. Once a first one of fasteners is struck out of a striking path, a connection strip for holding the fasteners is lifted by a biasing force of a return biasing member while the carrier member is displaced from the lower position to the upper position.

### CROSS-REFERENCE TO RELATED APPLICATION

This application claims priority from Taiwanese application no. 102128685, filed on Aug. 9, 2013, the disclosure of which is incorporated in its entirety herein by reference.

### FIELD OF THE INVENTION

This invention relates to a fastener feeding device, more particularly to a fastener feeding device for a driving tool.

### BACKGROUND OF THE INVENTION

As shown in FIG. 1, a gas combustion type driving tool 1 disclosed in U.S. Pat. No. 7,556,182 B2 includes a striking piston 121 driven by a combustion gas to move within a striking cylinder 15 of a tool body 11 so as to move a driver 122 out of a nose part 111 for driving a fastener 2 into a targeted object (A). A fastener feeding device 14 includes a feed cylinder 141 and a feed piston 142 urged by a spring 143 to move in a feeding direction within the feed cylinder 141. The feed cylinder 141 is in fluid communication with a combustion chamber 10 through a gas conduit 13, and a delay piston/cylinder device 16 is disposed in the gas conduit 13. A first check valve 131 and a second check valve 132 are disposed downwardly of the delay piston/cylinder device 16, and a switch valve 17 is disposed between the second check valve 132 and the feed cylinder 141. In a nail driving operation, when the nose part 111 is pressed against the targeted object (A) to cause a contact arm 18 to move upward, the combustion gas is injected into the combustion chamber 10 and is mixed with air. Once a trigger 19 is pulled, the mixed gas is ignited, burned, and expanded explosively. The pressure of the combustion gas acts on the striking piston 121 to drive the nail 2. Meanwhile, the pressure of the combustion gas also acts on the delay piston/cylinder device 16, and the air which is introduced thereinto from the atmosphere through the first check valve 131 is compressed. When the pressure of the compressed air rises to a given pressure, the compressed air is admitted into the feed cylinder 141 through the second check valve 132 to thereby move the feed piston 142 against the spring 143 for performing a fastener feeding operation.

However, since the carbon content of the combustion gas is quite high, carbon may accumulate in the conduit 13 to adversely affect the fastener feeding operation.

To overcome the above problem, U.S. Pat. No. 8,485,407 B2 proposes a fastener driving tool for repeatedly feeding fasteners into a striking path of a driving tool without using a combustion gas-operated or electromechanical mechanism. Said fastener driving tool includes an uplifting unit having a pivotable member which is pivotable about a torsion axis parallel to the striking path and movable in a feeding direction, a claw member which is biased by a torsion spring to hold a second fastener during an upward movement of the fasteners when the pivotable member is displaced from a lower position to an upper position, and a lifting member which extends transversely. A force transmitting unit is disposed to couple a contact arm of the driving tool to the lifting member to effect the upward movement of the fasteners in response to a rearward displacement of the contact arm when the contact arm is pressed against a targeted object. Each time a user presses the contact arm against the targeted object, a fastener is fed into the striking path. If the user presses the contact arm against the targeted object without triggering a striking operation, the next time the user presses the contact arm against the targeted object, another fastener will be fed into the striking path, thereby resulting in a fastener jam.

### SUMMARY OF THE INVENTION

Therefore, an object of the present invention is to provide a fastener feeding device for a driving tool. In the driving tool, when a contact arm is pressed against a targeted object to cause a carrier member to be displaced from an upper position to a lower position, the carrier member will be retained in the lower position until a first one of fasteners is struck out of a striking path, thereby preventing fastener jams.

According to the present invention, a fastener feeding device for a driving tool is provided. The driving tool has a nose body, a contact arm, and a fastener assembly. The nose body extends in a longitudinal direction to terminate at a nose end, and defines a striking path and a feeding path. The striking path extends along a striking path line in the longitudinal direction (X). The feeding path extends along a feeding path line in a feeding direction transverse to the longitudinal direction. The contact arm is movably disposed on the nose end and is capable of making rearward displacement when pressed against a targeted object. The fastener assembly includes a plurality of fasteners displaced from one another in the feeding direction, and a connection strip which is non-stretchable in the feeding direction, which is configured to hold the fasteners, and which has a plurality of releasable retained portions that alternate with the fasteners. Each of the fasteners extends along a shank axis parallel to the striking path line. A first one of the fasteners is initially fed into the striking path. The fastener feeding device includes amounting seat, a fastener actuating unit, and a force transmitting unit. The mounting seat is adapted to be mounted to the nose body and under the striking path. The fastener actuating unit includes a carrier member and a return biasing member. The carrier member extends in the feeding direction to terminate at an actuated end and a butt end, and is disposed to be guided by and movable relative to the mounting seat in the feeding direction between an upper position, where the carrier member is closer to the striking path, and a lower position, where the carrier member is remote from the striking path. The return biasing member is disposed to bias the butt end of the carrier member toward the upper position. The force transmitting unit is configured to couple the contact arm to the actuated end such that the carrier member is displaced from the upper position to the lower position in response to the rearward displacement of the contact arm.

### BRIEF DESCRIPTION OF THE DRAWINGS

Other features and advantages of the present invention will become apparent in the following detailed description of the embodiment of the invention, with reference to the accompanying drawings, in which:

FIG. 1 is a sectional view of a conventional fastener driving tool;

FIG. 2 is an exploded perspective view of an embodiment of a fastener feeding device according to this invention;

FIG. 3 is a fragmentary perspective view showing the embodiment of a fastener driving tool;

FIG. 4 is a side view of the embodiment showing a contact arm in a normal position;

FIG. 5 is a cross-sectional view taken along line V-V of FIG. 4;

FIG. 6 is a cross-sectional view taken along line VI-VI of FIG. 5, showing a carrier member in an upper position;

FIG. 7 is a side view similar to FIG. 4 but showing the contact arm in a pressed position;

FIG. 8 is a cross-sectional view taken along line VIII-VIII of FIG. 7, showing the carrier member in a lower position; and

FIGS. 9 to 11 illustrate operation of the embodiment.

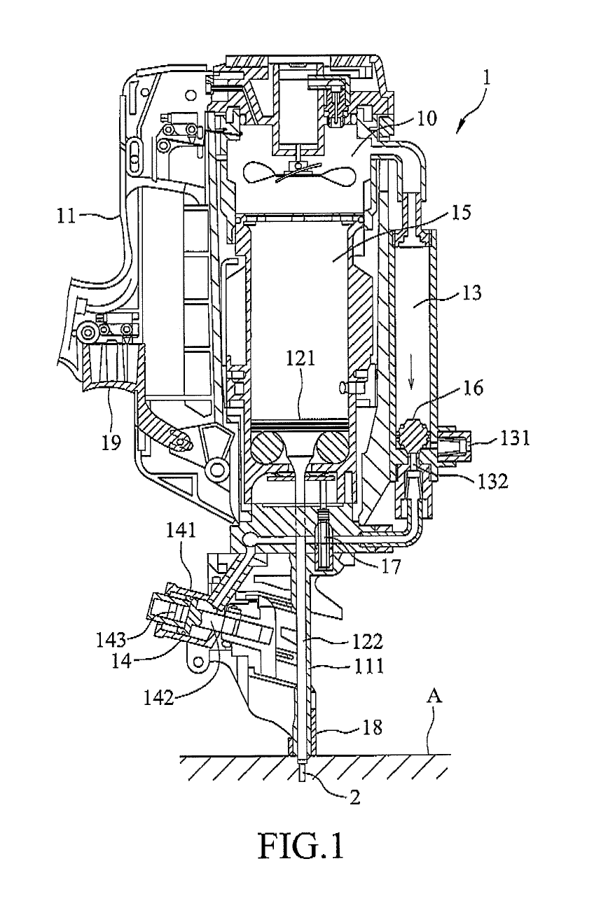

### DETAILED DESCRIPTION OF THE EMBODIMENT

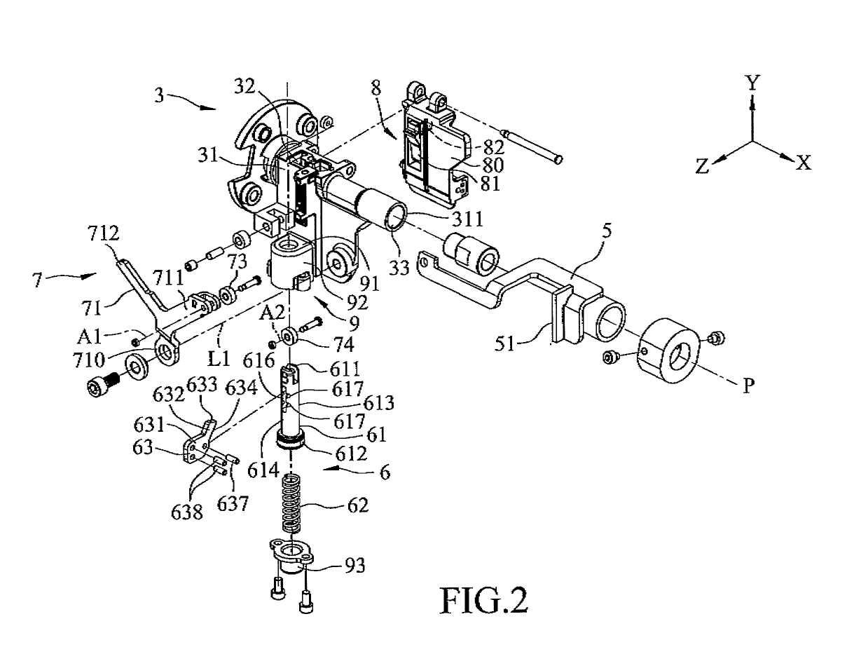

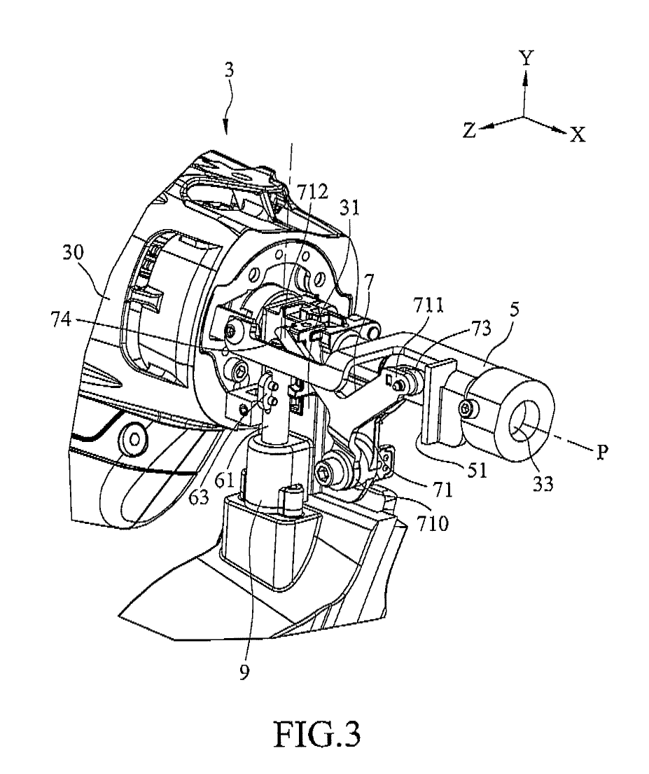

FIGS. 2 to 6 show an embodiment of a fastener feeding device for a driving tool 3 according to this invention. The driving tool 3 is a coil nailer and includes a main housing 30, a nose body 31, a contact arm 5, and a fastener assembly 4.

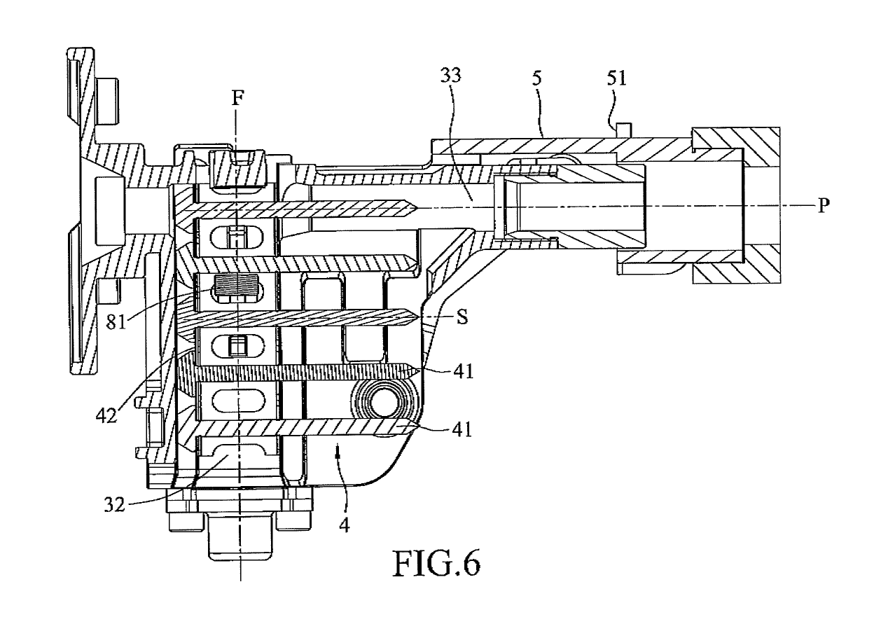

The nose body 31 extends forwardly from the main housing 30 in a longitudinal direction (X) to terminate at a nose end 311, and defines a feeding path 32 and a striking path 33. The striking path 33 extends along a striking path line (P) in the longitudinal direction (X). The feeding path 32 extends along a feeding path line (F) in a feeding direction (Y) transverse to the longitudinal direction (X) (see FIG. 6).

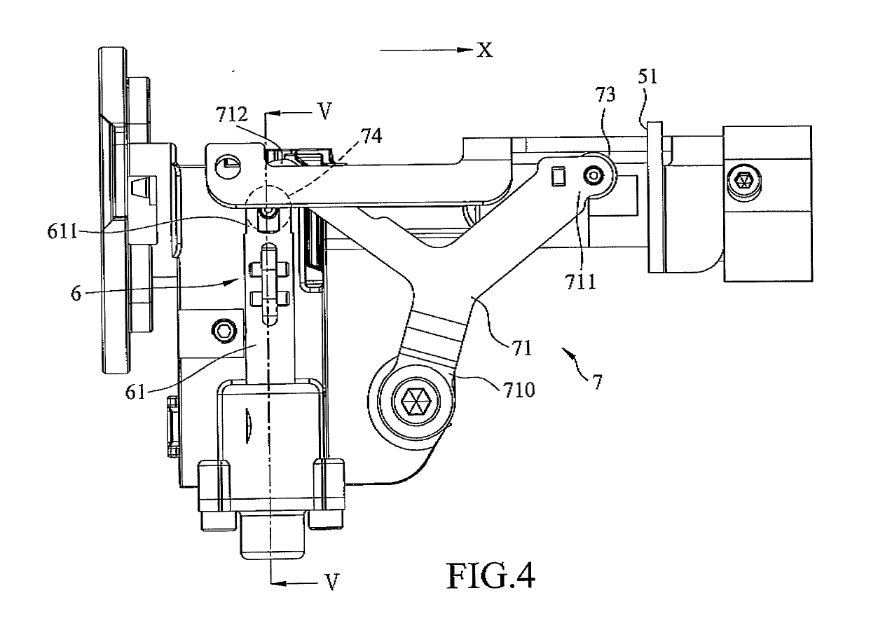

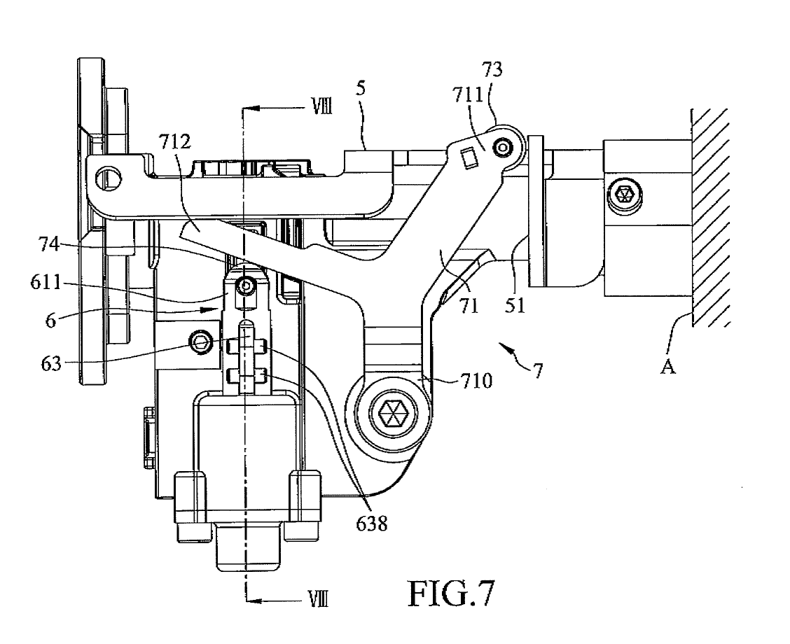

The contact arm 5 has an actuating surface 51 facing the main housing 30, extends in the longitudinal direction (X), and is movably disposed on the nose end 311 between a normal position (see FIG. 4) and a pressed position (see FIG. 7). Referring to FIG. 7, when the contact arm 5 is pressed against a targeted object (A), it displaces from the normal position to the pressed position, thereby making a rearward displacement.

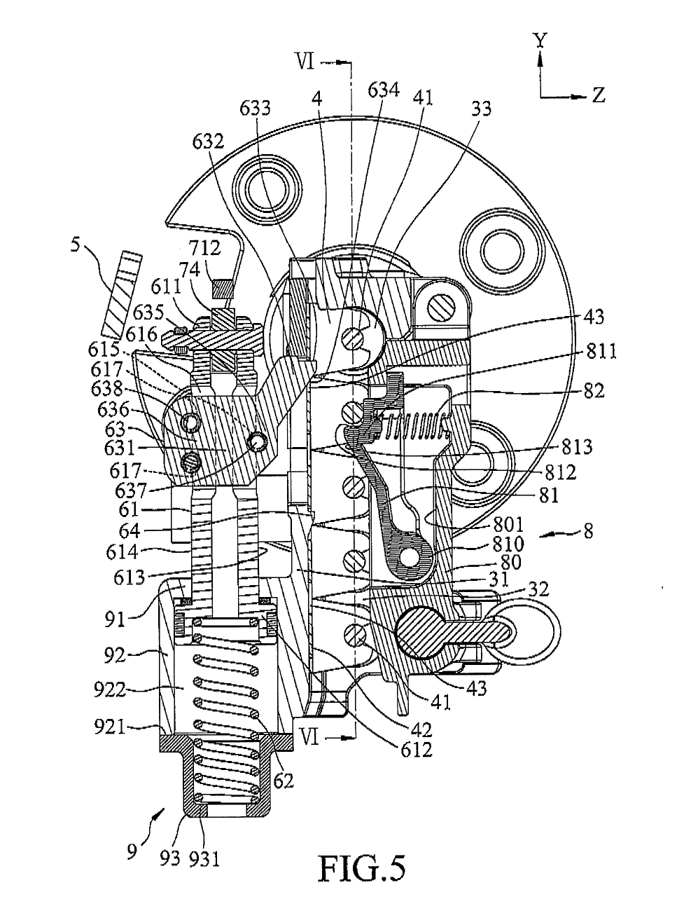

As best shown in FIGS. 5 and 6, the fastener assembly 4 includes a plurality of fasteners 41 and a connection strip 42. The fasteners 41 are disposed in the feeding path 32 and displaced from one another in the feeding direction (Y). Each of the fasteners 41 extends along a shank axis (S) parallel to the striking path line (P), and a first one of the fasteners 41 is initially fed into the striking path 33. The connection strip 42 is non-stretchable and non-compressible in the feeding direction (Y), is configured to hold the fasteners 41, and has a plurality of releasable retained portions 43 alternating with the fasteners 41. Furthermore, the connection strip 42 is made of a semi-rigid, flexible plastic material, and each of the releasable retained portions 43 is in the form of a hole. The fasteners 41 may be nails, staples, etc.

The fastener feeding device according to the embodiment of this invention includes a fastener actuating unit 6, a force transmitting unit 7, a holding frame 8, and a mounting unit 9.

As best shown in FIG. 5, the mounting unit 9 includes a mounting seat 91, a tubular wall 92, and a cap member 93. The mounting seat 91 is adapted to be mounted to the nose body 31 and under the striking path 33. The tubular wall 92 extends from a periphery of the mounting seat 91 in the feeding direction (Y) to terminate at a surrounding bottom wall 921 and to define a guiding slot 922 for guiding displacement of a carrier member 61 of the fastener actuating unit 6. The cap member 93 is mounted to the surrounding bottom surface 921 to cover the guiding slot 922, and defines an inner abutment surface 931 to confront the guiding slot 922.

The fastener actuating unit 6 includes the carrier member 61, a return biasing member 62, and a claw member 63.

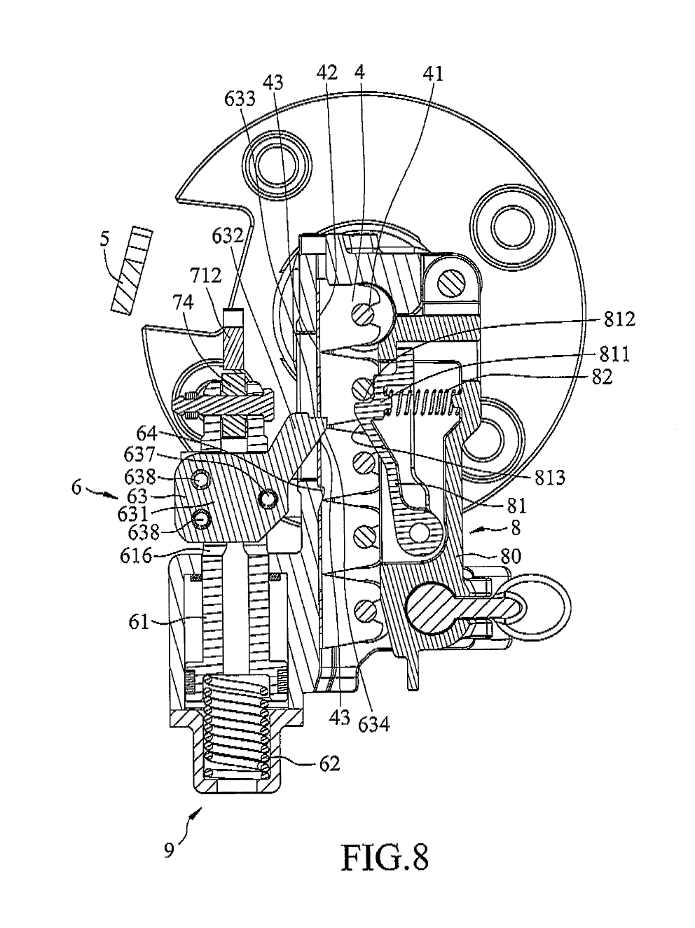

The carrier member 61 extends in the feeding direction (Y) to terminate at an actuated end 611 and a butt end 612, and is disposed to be guided by and movable relative to the mounting seat 91 in the feeding direction (Y) between an upper position (see FIGS. 4 and 5), where the carrier member 61 is closer to the striking path 33, and a lower position (see FIGS. 7 and 8), where the carrier member 61 is remote from the striking path 33.

As best shown in FIGS. 2 and 5, the carrier member 61 has a left side surface 613 adapted to face the fastener assembly 4, and a right side surface 614 opposite to the left side surface 613 in a left-to-right direction (Z) transverse to both the longitudinal direction (X) and the feeding direction (Y). The left side surface 613 has a left bearing region 615 (see FIG. 5) and an elongated slot 616 extending from the left bearing region 615 in the left-to-right direction (Z) through the right side surface 614. The right side surface 614 has two right bearing regions 617 spaced apart from each other in the feeding direction (Y).

The return biasing member 62 is disposed to bias the carrier member 61 toward the upper position. In this embodiment, the returning biasing member 62 is disposed between the inner abutment surface 931 and the butt end 612 to bias the carrier member 61 toward the upper position.

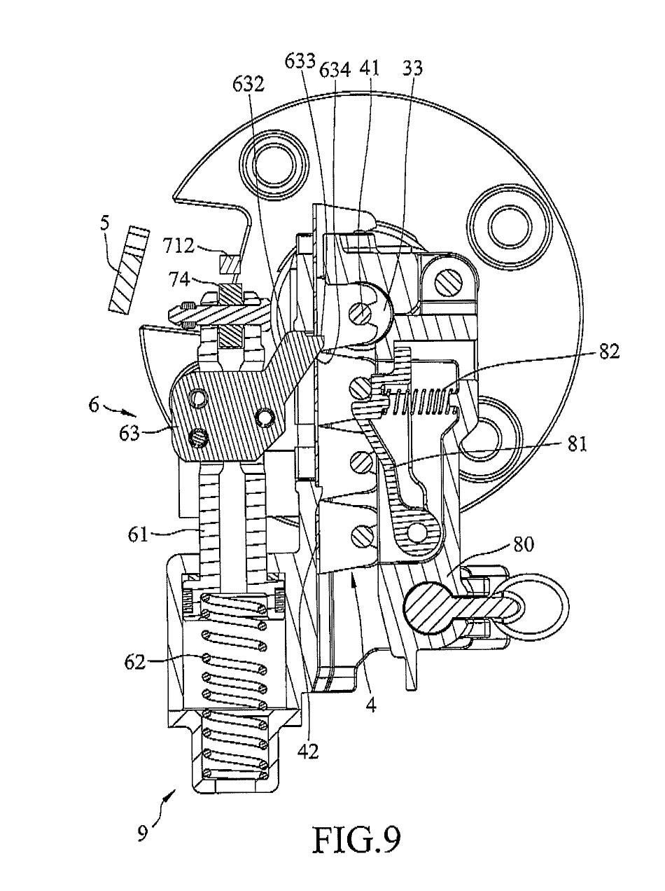

The claw member 63 has a base 631 and a claw end 632. The base 631 is loosely pivoted to the carrier member 61. The claw end 632 extends from the base 631 into the feeding path 32, and is configured to releasably retain a first one of the releasable retained portions 43. When the carrier member 61 is displaced from the upper position (FIG. 5) to the lower position (FIG. 8) against biasing force of the return biasing member 62, the claw end 632 is dragged downward from the first one of the releasable retained portions 43 to a second one of the releasable retained portions 43. As shown in FIGS. 8 and 9, once the first one of the fasteners 41 is struck out of the striking path 33 and the contact arm 5 is removed from the targeted object (A) (see FIG. 4), the connection strip 42 is permitted to be lifted by the biasing force of the return biasing member 62 through the claw end 632 and the carrier member 61 for feeding a second one of the fasteners 41 into the striking path 33.

The claw end 632 has a retaining surface 633 and an inwardly inclined surface 634. The retaining surface 633 is configured to face upwardly so as to retain the second one of the releasable retained portions 43 for lifting the connection strip 42 when the carrier member 61 is displaced from the lower position (FIG. 8) to the upper position (FIG. 9). The inwardly inclined surface 634 is configured to facilitate removal of the claw end 632 from the first one of the releasable retained portions 43 when the carrier member 61 is displaced from the upper position (FIG. 5) to the lower position (FIG. 8).

With reference to FIGS. 2 and 5, in this embodiment, the base 631 is disposed to extend through the elongated slot 616 and has proximate and distal regions 635, 636 relative to the claw end 632. The claw member 63 further has a pivot shaft 637 and two holding shafts 638. The pivot shaft 637 extends from the proximate region 635 in the longitudinal direction (X) to be loosely journaled on the left bearing region 615. The holding shafts 638 extend from the distal region 636 in the longitudinal direction (X) to be loosely journaled on the right bearing regions 617, respectively, so as to permit the claw member 63 to be shiftable relative to the carrier member 61 in the feeding direction (Y), when the carrier member 61 is displaced from the upper position (FIG. 5) to the lower position (FIG. 8).

The force transmitting unit 7 is configured to couple the contact arm 5 to the actuated end 611 such that in response to the rearward displacement of the contact arm 5, the carrier member 61 is displaced from the upper position to the lower position.

As shown in FIGS. 2, 4, and 7, the force transmitting unit 7 includes a Y-shaped lever member 71 having a pivot end 710, a power end 711, and a weight end 712. The pivot end 710 is pivotally mounted on the nose body 31 about a fulcrum axis (L1). The power end 711 is configured to be in rollable contact with the actuating surface 51 of the contact arm 5 so as to transform the rearward movement of the contact arm 5 to an angular movement of the power end 711 about the fulcrum axis (L1). The weight end 712 is disposed opposite to the power end 711, and is configured to be moved angularly about the fulcrum axis (L1) when the power end 711 is moved angularly about the fulcrum axis (L1). The weight end 712 is in rollable contact with the actuated end 611 so as to transform an angular movement of the weight end (712) to a linear displacement of the carrier member 61 from the upper position (FIGS. 4 and 5) to the lower position (FIGS. 7 and 8).

In this embodiment, the force transmitting unit 7 further includes first and second rollers 73, 74. The first roller 73 is rotatably mounted on the power end 711 to rotate about a first axis (A1) (see FIG. 2). The second roller 74 is rotatably mounted on the actuated end 611 of the carrier member 61 to rotate about a second axis (A2). In response to the rearward displacement of the contact arm 5, the first roller 73 rotates on the actuating surface 51 to move upwardly, resulting in a counterclockwise angular movement of the Y-shaped lever member 71 about the fulcrum axis (L1) , i.e., the angular movements of the power end 711 and the weight end 712. Meanwhile, the second roller 74 rotates on a surface of the weight end 712 to move downwardly, resulting in the linear displacement of the carrier member 61 from the upper position (FIG. 4) to the lower position (FIG. 7).

The holding frame 8 includes a frame body 80, a holding member 81, and a spring 82.

With reference to FIG. 5, the frame body 80 is adapted to be mounted to the nose body 31 and is disposed opposite to the mounting seat 91 relative to the feeding path line (F). The frame body 80 has a mounting surface 801 offset from the feeding path line (F).

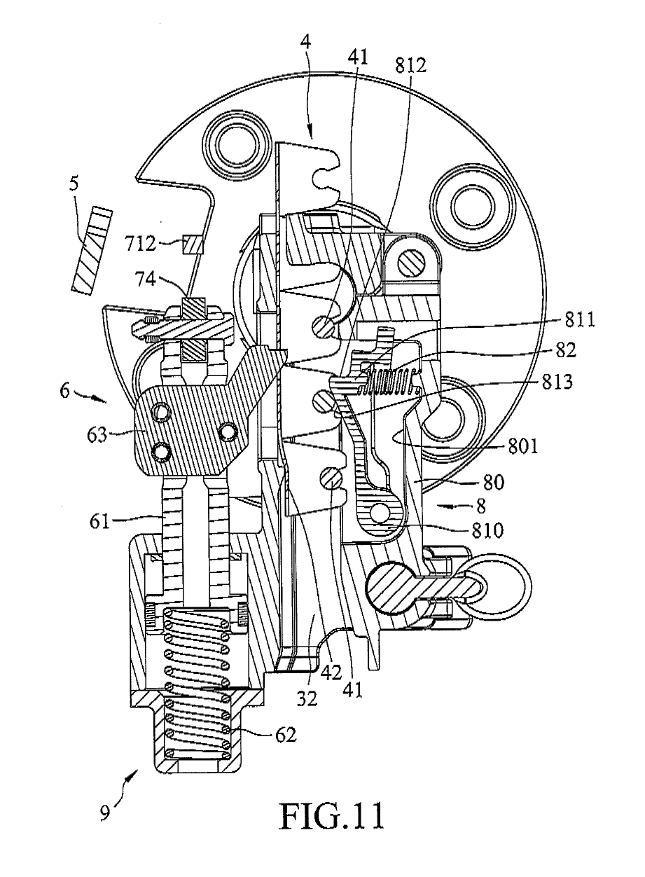

The holding member 81 has a pivot end 810 and a gripping end 811. The pivot end 810 is pivotally mounted to the frame body 80. The gripping end 811 radially extends from the pivot end 810 and is angularly movable between a holding position (FIG. 5), where the gripping end 811 is remote from the mounting surface 801 and stands in the feeding path 32, and a yielded position (FIG. 11), where the gripping end 811 is close to the mounting surface 801. The spring 82 is disposed to bias the gripping end 811 to the holding position. When the carrier member 61 is displaced from the upper position to the lower position to permit the claw end 632 to be dragged downward, the gripping end 811 is kept in the holding position by a biasing force of the spring 82 and grips the second one of the fasteners 41 so as to prevent the connection strip 42 from being moved with the claw end 632.

In this embodiment, the gripping end 811 has an engaging surface 812 and a cam surface 813. The engaging surface 812 is configured to be engaged with the second one of the fasteners 41 when the gripping end 811 is in the holding position. The cam surface 813 is configured such that when the carrier member 61 is moved from the lower position to the upper position to feed the second one of the fasteners 41 into the striking path 33, a third one of the fasteners 41 is permitted to exert a camming action on the cam surface 813 to counteract the biasing force of the spring 82 until being moved to the engaging surface 812 to be engaged therewith.

As shown in FIGS. 5 and 8, the fastener feeding device further includes a positioning check member 64. The positioning check member 64 is disposed between the mounting seat 91 and the claw end 632, and is configured to be releasably engagable with a third one of the releasable retained portions 43 such that simultaneously with the displacement of the carrier member 61 from the lower position (FIG. 8) to the upper position (FIG. 9), the positioning check member 64 is displaced from engagement with the third one of the releasable retained portions 43 to be in engagement with a fourth one of the releasable retained portions 43 so as to limit the extent of a displacement of the connection strip 42, thereby ensuring that the second one of the fasteners 41 fed into the striking path 33 is in line with the striking path line (P).

Referring to FIGS. 4 to 6, when the first one of the fasteners 41 is fed into the striking path 33, the second one of the fasteners 41 is held by the gripping end 811 of the holding member 81, the carrier member 61 is in the upper position, the claw end 632 engages the first one of the releasable retained portions 43, and the positioning check member 64 is engaged with the third one of the releasable retained portions 43.

In operation, when the contact arm 5 is pressed against the targeted object (A) and is thereby caused to make the rearward displacement (see FIG. 7), the first roller 73 rotates on the actuating surface 51 to move upwardly to cause the lever member 71 to rotate counterclockwise, and the second roller 74 rotates on the surface of the weight end 712 to move downwardly against the biasing force of the return biasing member 62, to thereby displace the carrier member 61 from the upper position (FIG. 5) to the lower position (FIG. 8). The claw member 63 is moved with the carrier member 61 such that the claw end 632 is dragged downward to retain the second one of the releasable retained portions 43 (FIG. 8).

If the first one of the fasteners 41 is not struck out of the striking path 33, even if the contact arm 5 is removed from the targeted object (A) and the carrier member 61 is urged to move to the upper position due to the biasing force of the return biasing member 62, the carrier member 61 will remain at the lower position (FIG. 8). This is because the return of the carrier member 61 to the upper position requires lifting of the claw end 632 and upward movement of the connection strip 42, which is not possible since the first one of the fasteners 41 is positioned in the striking path 33 and the connection strip 42 is non-compressible. Thus, if the user repeatedly presses the contact arm 5 against the targeted object (A) without pressing a trigger (not shown), the second one of the fasteners 41 will not be fed into the striking path 33 to cause a fastener jam.

Once the first one of the fasteners 41 is struck out of the striking path 33, the carrier member 61 is moved to the upper position to permit the connection strip 42 to be lifted by the biasing force of the return biasing member 62 through the claw end 632 and the carrier member 61 so as to feed the second one of the fasteners 41 into the striking path 33 (FIG. 9). Meanwhile, the third one of the fasteners 41 exerts the camming action on the cam surface 813 until the third one of the fasteners 41 is moved to and engaged with the engaging surface 812. With the upward movement of the connection strip 42, the positioning check member 64 is displaced to be in engagement with the fourth one of the releasable retained portions 43.

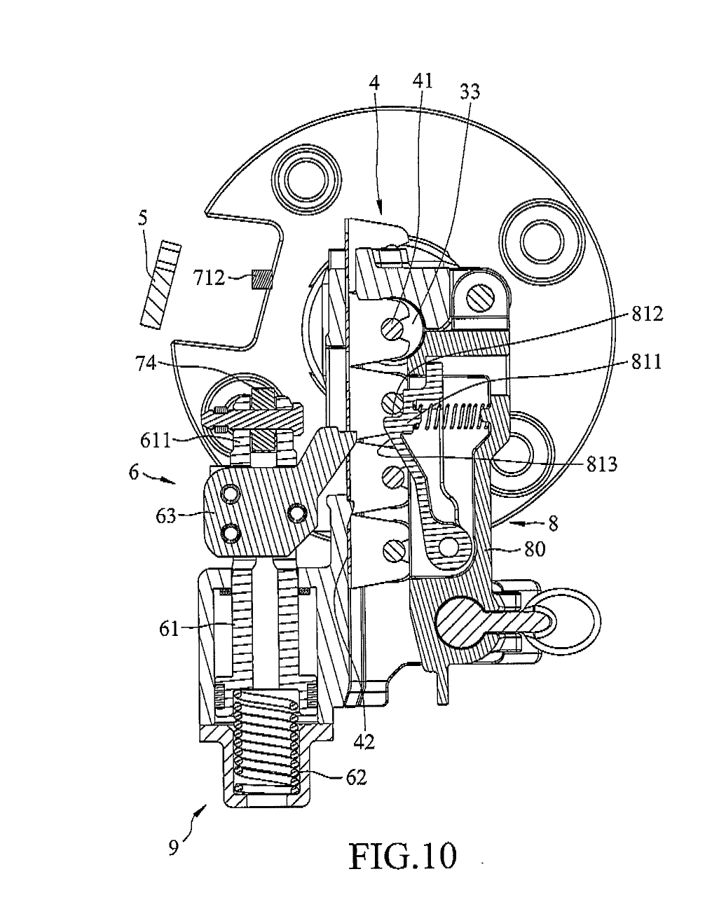

FIG. 10 shows that the second one of the fasteners 41 is fed into the striking path 33, and the carrier member 61 is in the lower position. FIG. 11 shows that the camming action between a fourth one of the fasteners 41 and the cam surface 813 after the second one of the fasteners 41 is struck out of the striking path 33.

While the present invention has been described in connection with what is considered the most practical embodiment, it is understood that this invention is not limited to the disclosed embodiment but is intended to cover various arrangements included within the spirit and scope of the broadest interpretations and equivalent arrangements.

What is claimed is:

1. A fastener feeding device for a driving tool that has
a nose body which extends in a longitudinal direction to terminate at a nose end, and which defines a striking path extending along a striking path line in the longitudinal direction and a feeding path extending along a feeding path line in a feeding direction transverse to the longitudinal direction,
a contact arm movably disposed on the nose end and capable of making rearward displacement when pressed against a targeted object, and
a fastener assembly including a plurality of fasteners displaced from one another in the feeding direction, and a connection strip which is non-stretchable in the feeding direction, which is configured to hold the fasteners, and which has a plurality of releasable retained portions that alternate with the fasteners, each of the fasteners extending along a shank axis parallel to the striking path line, a first one of the fasteners being initially fed into the striking path, said fastener feeding device comprising:
amounting seat adapted to be mounted to the nose body and under the striking path;
a fastener actuating unit including
a carrier member which extends in the feeding direction to terminate at an actuated end and a butt end, and which is disposed to be guided by and movable relative to said mounting seat in the feeding direction between an upper position, where said carrier member is closer to the striking path, and a lower position, where said carrier member is remote from the striking path, and
a return biasing member disposed to bias said butt end of said carrier member toward the upper position; and
a force transmitting unit configured to couple the contact arm to said actuated end such that said carrier member is displaced from the upper position to the lower position in response to the rearward displacement of the contact arm.

2. The fastener feeding device of claim 1, wherein said fastener actuating unit further includes a claw member having a base and a claw end which extends from said base into the feeding path, and which is configured to releasably retain a first one of the releasable retained portions, said base being loosely pivoted to said carrier member such that when said carrier member is displaced from the upper position to the lower position against biasing force of said return biasing member, said claw end is dragged downward from the first one of the releasable retained portions to a second one of the releasable retained portions, and such that once the first one of the fasteners is struck out of the striking path, the connection strip is permitted to be lifted by the biasing force of said return biasing member through said claw end and said carrier member for feeding a second one of the fasteners into the striking path.

3. The fastener feeding device of claim 2, wherein said claw end has
a retaining surface configured to face upwardly so as to retain the second one of the releasable retained portions for lifting the connection strip when said carrier member is displaced from the lower position to the upper position, and
an inwardly inclined surface configured to facilitate removal of said claw end from the first one of the releasable retained portions when said carrier member is displaced from the upper position to the lower position.

4. The fastener feeding device of claim 1, wherein said force transmitting unit includes a lever member which is pivotally mounted on the nose body about a fulcrum axis, and which has
a power end configured to be in reliable contact with the contact arm so as to transform the rearward movement of the contact arm to an angular movement of said power end about the fulcrum axis, and
a weight end disposed opposite to said power end and configured to be moved angularly about the fulcrum axis when said power end is moved angularly about the fulcrum axis, said weight end being in reliable contact with said actuated end so as to transform an angular movement of said weight end to a linear displacement of said carrier member from the upper position to the lower position.

5. The fastener feeding device of claim 1, further comprising:
a tubular wall extending from a periphery of said mounting seat to terminate at a surrounding bottom surface and to define a guiding slot for guiding displacement of said carrier member; and
a cap member which is mounted to said surrounding bottom surface to cover said guiding slot, and which defines an inner abutment surface to confront said guiding slot, said return biasing member being disposed between said inner abutment surface and said butt end.

6. The fastener feeding device of claim 2, further comprising a holding frame which includes
a frame body adapted to be mounted to the nose body, and disposed opposite to said mounting seat relative to the feeding path line, said frame body having a mounting surface offset from the feeding path line;
a holding member having a pivot end pivotally mounted to said frame body, and a gripping end radially extending from said pivot end and angularly movable between a holding position, where said gripping end is remote from said mounting surface and stands in the feeding path, and a yielded position, where said gripping end is close to said mounting surface; and
a spring disposed to bias said gripping end to the holding position, said holding member being configured such that when said carrier member is displaced from the upper position to the lower position to permit said claw end to be dragged downward, said gripping end is kept in the holding position by a biasing force of said spring to grip the second one of the fasteners so as to prevent the connection strip from being moved with said claw end.

7. The fastener feeding device of claim 6, wherein said gripping end has
an engaging surface configured to be engaged with the second one of the fasteners when said gripping end is in the holding position, and
a cam surface configured such that when said carrier member is moved from the lower position to the upper position to feed the second one of the fasteners into the striking path, a third one of the fasteners is permitted to exert a camming action on said cam surface to counteract the biasing force of said spring, until the third one of the fasteners is moved to said engaging surface so as to be engaged therewith.

8. The fastener feeding device of claim 2, further comprising a positioning check member disposed between said mounting seat and said claw end, and configured to be releasably engagable with a third one of the releasable retained portions such that simultaneously with the displacement of said carrier member from the lower position to the upper position, said positioning check member is displaced from engagement with the third one of the releasable retained portions to be in engagement with a fourth one of the releasable retained portions so as to limit extent of a displacement of the connection strip, thereby ensuring that the second one of the fasteners fed into the striking path is in line with the striking path line.

9. The fastener feeding device of claim 2, wherein:
said carrier member has a left side surface adapted to face the fastener assembly, and a right side surface opposite to said left side surface in a left-to-right direction transverse to both the longitudinal direction and the feeding direction, said left side surface having a left bearing region and an elongated slot extending from said left bearing region in the left-to-right direction through said right side surface, said right side surface having two right bearing regions spaced apart from each other in the feeding direction;
said base is disposed to extend through said elongated slot and has proximate and distal regions relative to said claw end; and
said claw member further has
a pivot shaft extending from said proximate region in the longitudinal direction to be loosely journaled on said left bearing region, and
two holding shafts extending from said distal region in the longitudinal direction to be loosely journaled on said right bearing regions, respectively, so as to permit said claw member to be shiftable relative to said carrier member in the feeding direction when said carrier member is displaced from the upper position to the lower position.
